(19) United States
(12) Patent Application Publication
(10) Pub. No.: US 2004/0058090 A1
(43) Pub. Date: Mar. 25, 2004

(54) Low temperature UV pretreating of porous low-k materials

(76) Inventors: Carlo Waldfried, Falls Church, VA (US); Qingyuan Han, Columbia, MD (US); Orlando Escorcia, Falls Church, VA (US); Ivan L. Berry III, Ellicott City, MD (US); Jeff Bremmer, Midland, MI (US); Phil Dembowski, Midland, MI (US)

Correspondence Address: DINSMORE & SHOHL LLP, ONE DAYTON CENTRE, SUITE 500, ONE SOUTH MAIN STREET, DAYTON, OH, 45402-2023, US

(21) Appl. No.: 10/623,712

(22) Filed: Jul. 21, 2003

Related U.S. Application Data
(63) Continuation-in-part of application No. 09/952,398, filed on Sep. 14, 2001.

(51) Int. Cl. B05D 3/06

(52) U.S. Cl. 427/558; 427/487

(57) ABSTRACT

A method of forming a coating on a substrate. A coating is formed on a substrate by depositing a solution comprising a resin molecule containing at least 2 Si—H groups, at least 2 Si—CH₃ groups, or a combination thereof, and, a solvent in a manner in which at least about 5 volume % of the solvent remains in the coating after deposition, followed by exposing the coating to UV radiation at a power and wavelength spectrum sufficient to cause hydrolysis of the Si—H groups, Si—CH₃ groups, or combination thereof, and at least partial condensation, and evaporating the solvent from the coating to form a porous network coating. The method enables production of low-k materials without treatment with ammonia.

### CROSS-REFERENCE TO RELATED APPLICATIONS

This application is a continuation-in-part of U.S. patent application Ser. No. 09/952,398, filed Sep. 14, 2001 and entitled “ULTRAVIOLET CURING PROCESS FOR POROUS LOW-K MATERIALS”, which is related to U.S. patent application Ser. No. 09/528,835, filed Mar. 20, 2000 and entitled “HIGH MODULUS, LOW DIELECTRIC CONSTANT COATINGS” (now U.S. Pat. No. 6,576,300) and U.S. patent application Ser. No. 09/681,332, filed Mar. 19, 2001 and entitled “PLASMA CURING PROCESS FOR POROUS SILICA THIN FILM” (now U.S. Pat. No. 6,558,755), the disclosures of which are incorporated herein by reference.

### BACKGROUND OF THE INVENTION

This invention relates generally to a process which is employed in manufacturing semiconductor chips. More particularly, the invention relates to a low temperature UV pretreating process for porous materials that are utilized as integrated circuit (IC) dielectrics. The process enables production of low-k materials without treatment with ammonia.

New materials with low dielectric constants (known in the art as “low-k dielectrics”) are being investigated for their potential use as insulators in semiconductor chip designs. A low dielectric constant material aids in enabling further reductions in the integrated circuit feature dimensions. In conventional IC processing, SiO₂ is used as a basis for the dielectric material resulting in a dielectric constant of about 3.9. The substance with the lowest dielectric constant is air (k=1.0). Therefore, porous dielectrics are very promising candidates since they have the potential to provide very low dielectric constants. Unfortunately, however, such porous low-k dielectrics typically have the problem of insufficient mechanical strength.

Thin film dielectric coatings on electric devices are known in the art. For instance, U.S. Pat. Nos. 4,749,631 and 4,756,977, to Haluska et al., disclose silica based coatings produced by applying solutions of silicon alkoxides or hydrogen silsesquioxane, respectively, to substrates and then heating the coated substrates to a temperature between 200 and 1000° C. The dielectric constant of these coatings is often too high for certain electronic devices and circuits.

U.S. Pat. Nos. 4,847,162 and 4,842,888, to Haluska et al., teach the formation of nitrided silica coatings by heating hydrogen silsesquioxane resin and silicate esters, respectively, to a temperature between 200 and 1000° C. in the presence of ammonia.

Glasser et al., Journal of Non-Crystalline Solids, 64 (1984) pp. 209-221, teaches the formation of ceramic coatings by heating tetraethoxysilane in the presence of ammonia. This reference teaches the use of anhydrous ammonia and that the resulting silica coatings are nitrided.

U.S. Pat. No. 4,636,440, to Jada, discloses a method of reducing the drying time for a sol-gel coated substrate comprising exposing the substrate to aqueous quaternary ammonium hydroxide and/or alkanol amine compounds. Jada requires that the coating be dried prior to heating. It is specifically limited to hydrolyzed or partially hydrolyzed silicon alkoxides.

U.S. Pat. Nos. 5,262,201, to Chandra et al., and 5,116,637, to Baney et al., teach the use of basic catalysts to lower the temperature necessary for the conversion of various preceramic materials, all involving hydrogen silsesquioxane, to ceramic coatings. These references teach the removal of solvent before the coating is exposed to the basic catalysts.

U.S. Pat. No. 5,547,703, to Camillefti et al., teaches a method for forming low dielectric constant Si—O containing coatings on substrates comprising heating a hydrogen silsesquioxane resin successively under wet ammonia, dry ammonia, and oxygen. The resultant coatings have dielectric constants as low as 2.42 at 1 MHz. This reference teaches the removal of solvent before converting the coating to a ceramic.

U.S. Pat. No. 5,523,163, to Balance et al., teaches a method for forming Si—O containing coatings on substrates comprising heating a hydrogen silsesquioxane resin to convert it to a Si—O containing ceramic coating and then exposing the coating to an annealing atmosphere containing hydrogen gas. The resultant coatings have dielectric constants as low as 2.773. The reference teaches the removal of solvent before converting the coating to a ceramic.

U.S. Pat. No. 5,618,878, to Syktich et al., discloses coating compositions containing hydrogen silsesquioxane resin dissolved in saturated alkyl hydrocarbons useful for forming thick ceramic coatings. The alkyl hydrocarbons disclosed are those up to dodecane. The reference does not teach exposure of the coated substrates to basic catalysts before solvent removal.

U.S. Pat. No. 6,231,989, to Chung et al., entitled “METHOD OF FORMING COATINGS” discloses a method of making porous network coatings with low dielectric constants. The method comprises depositing a coating on a substrate with a solution comprising a resin containing at least 2 Si—H groups and a solvent in a manner in which at least 5 volume % of the solvent remains in the coating after deposition. The coating is then exposed to an environment comprising a basic catalyst and water. Finally, the solvent is evaporated from the coating to form a porous network. If desired, the coating can be cured by heating to form a ceramic. Films made by this process have dielectric constants in the range of 1.5 to 2.4 with an elastic modulus between about 2 and about 3 GPa.

Low-k dielectric materials produced by spin-on and chemical vapor deposition processes or by a self-assembly process typically require a curing process subsequent to the deposition. Typical process conditions for curing low-k films include nitrogen purged furnace anneals at temperatures between about 350 and about 450° C. for 30 to 80 minutes. As was described in U.S. patent application Ser. Nos. 09/681,332 (now U.S. Pat. No. 6,558,755), 09/952,649, 09/906,276, and 09/952,398, and Attorney Docket No. AXC 0001 13 (01-SM5-218 CIP2), the disclosures of which are incorporated herein by reference, instead of thermally curing and plasma treating, the low-k films can be plasma or UV cured at substantially shorter times or at lower temperatures, eliminating the need for prior furnace curing and therefore reducing the total thermal budget.

As noted herein, there are different methods for generating porous low-k films, some of which require the following process sequence: (i) spin-on of the low-k resin, (ii) ammonia treatment to gelate the low-k material and provide initial strength to the low-k film, (iii) hot plate heating to remove the remaining solvents, and (iv) furnace or plasma/UV cure to crosslink the low-k resin structures. One of the process steps, the ammonia treatment, can be difficult to control, may be costly, and has the potential to cause adverse effects for other process steps, which can affect overall semiconductor manufacturability. Accordingly, the present inventors have recognized a need for improvements in the design of methods for processing porous low-k films.

### SUMMARY OF THE INVENTION

The present invention meets the above-mentioned need by providing a low-temperature UV pretreating process for porous low-k materials. Although the present invention is not limited to specific advantages or functionality, it is noted that the low-temperature UV pretreating process eliminates any undesired ammonia treatment that is employed in the semiconductor fabrication process, in particular that for the process for fabricating porous low-k materials. This can have the advantage of overall improved manufacturability, as well as improved process control and cost-effectiveness for gelation of dielectric resins. Furthermore, the low-temperature UV pretreatment enables an improved and more efficient process flow, with a reduced number of process steps, and the ability to conduct the complete low-k film deposition and cure process in an integrated manufacturing tool.

In accordance with one embodiment of the invention, a method of forming a coating on a substrate is provided comprising depositing a coating on a substrate with a solution comprising a resin molecule containing at least 2 Si—H groups, at least 2 Si—CH₃ groups, or a combination thereof, and a solvent in a manner in which at least about 5 volume % of the solvent remains in the coating after deposition; exposing the coating to UV radiation at a power and wavelength spectrum sufficient to cause hydrolysis of the Si—H groups, Si—CH₃ groups, or combination thereof, and at least partial condensation; and evaporating the solvent from the coating to form a porous network coating. The porous network coating formed by this embodiment of the present invention does not require treatment with ammonia and can serve as a starting material for processes that produce materials having a low dielectric constant and an improved elastic modulus and material hardness, which are described herein.

In accordance with another embodiment of the present invention, an ammonia-free process for forming a coating on a substrate is provided comprising depositing a coating on a substrate with a solution comprising a resin molecule containing at least 2 Si—H groups, at least 2 Si—CH₃ groups, or a combination thereof, and a solvent in a manner in which at least about 5 volume % of the solvent remains in the coating after deposition; gelating the resin without the use of ammonia by exposing the coating to UV radiation at a power and wavelength spectrum sufficient to cause hydrolysis of the Si—H groups, Si—CH₃ groups, or combinations thereof, and at least partial condensation; and evaporating the solvent from the coating to form a porous network coating.

These and other features and advantages of the invention will be more fully understood from the following detailed description of the invention taken together with the accompanying drawings. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following figures, where like structure is indicated with like reference numerals and in which:

FIG. 1 is a chart illustrating the FTIR spectra of untreated and room temperature UV pretreated XLK porous HSQ-based dielectric material;

FIG. 2 is a chart illustrating the FTIR spectra for MSQ-based porous low-k films which were thermally cured, thermally cured and UV cured in O₂, and thermally cured and UV cured in N₂;

FIG. 3 is a chart illustrating the FTIR spectra for HSQ-based porous low-k films which were uncured, UV cured in O₂, and UV cured in N₂; and

FIG. 4 is a chart illustrating the FTIR spectra for 5% MSQ/95% HSQ-based porous low-k films which were uncured, UV cured in O₂, and UV cured in N₂.

Skilled artisans appreciate that elements in the figures are illustrated for simplicity and clarity and have not necessarily been drawn to scale. For example, the dimensions of some of the elements in the figures may be exaggerated relative to other elements to help to improve understanding of the embodiments of the present invention.

### DETAILED DESCRIPTION OF THE INVENTION

The present invention is based on the discovery that UV curing virtually any porous dielectric material, without the necessity of thermally curing the material, increases the elastic modulus (Young's modulus) and material hardness of the porous material while maintaining its low dielectric constant properties. The porous dielectric material can include organic materials, inorganic materials, or combinations thereof. More particularly, the dielectric material can include, but is not limited to, hydrogen silsesquioxane (HSQ) dielectric materials, methylsilsesquioxane (MSQ) dielectric materials, and combinations thereof, which can be produced by depositing a dielectric coating on a substrate using spin-on, chemical vapor deposition (CVD), plasma assisted CVD, evaporation, reactive evaporation, or self-assembled processes. The porous dielectric materials can have porogen-generated, solvent-formed, or molecular engineered pores, which may be interconnected or closed, and which may be distributed random or ordered, such as vertical pores.

For some low-k materials, post-UV treating UV cured porous dielectric materials, using different wavelengths or temperatures, produces a material having a lower dielectric constant, and of-equal or further improved elastic modulus and material hardness.

The process of the present invention is particularly applicable to the deposition of coatings on electronic devices or electronic circuits where they can serve as interlevel dielectric layers, doped dielectric layers to produce transistor-like devices, pigment loaded binder systems containing silicon to produce capacitor and capacitor-like devices, multilayer devices, 3-D devices, silicon on insulator devices, super lattice devices, and the like. However, the choice of substrates and devices to be coated by the instant invention is limited only by the need for thermal and chemical stability of the substrate at the temperature and pressure used in the present invention. As such, the porous dielectric materials of the present invention can be used on substrates such as plastics including, for example, polyimides, epoxies, polytetrafluoroethylene and copolymers thereof, polycarbonates, acrylics and polyesters, ceramics, leather, textiles, metals, semiconductors and the like.

As used in the present invention, the expression “ceramic” includes ceramics such as amorphous silica and ceramic-like materials such as amorphous silica-like materials that are not fully free of carbon and/or hydrogen but are otherwise ceramic in character. The expressions “electronic device” or “electronic circuit” include, but are not limited to, silica-based devices, gallium arsenide based devices, silicon carbide based devices, focal plane arrays, opto-electronic devices, photovoltaic cells, and optical devices.

A porous dielectric material is needed as a starting material for the present invention. Typical HSQ-based dielectric materials for use with the present invention include FOx HSQ-based dielectric material and XLK porous HSQ-based dielectric material available from Dow Corning Corporation (Midland, Mich.). In addition, typical ultra low-k porous dielectric MSQ-based materials, made by spin-on processing, for use with the present invention are available from Chemat Technology, Inc. (Northridge, Calif.) and JSR Corporation (Tokyo, Japan).

The production of typical porous low-k dielectric materials for use with the present invention is well known in the art. One method of making such a porous dielectric material is the porous network coating disclosed in U.S. Pat. No. 6,231,989, which is incorporated herein by reference for its teaching on how to produce porous dielectric materials having ultra low dielectric constants. The patent describes the manufacture of ultra low dielectric constant coatings having a dielectric constant between about 1.5 and about 2.4, in which pores are introduced into HSQ-based films. HSQ-based films produced according to the method taught in U.S. Pat. No. 6,231,989, which have been cured under thermal conditions, contain about 20 to about 60% Si—H bonds density. When the dielectric constant of the coating is about 2.0, the coating has an elastic modulus of between about 2 and about 3 GPa.

The following method of producing a porous network coating is provided as an example of the production of a typical porous dielectric material. It is not the inventors' intent to limit their invention to only HSQ-based films. The process of the present invention is applicable to virtually any porous dielectric material.

The method of producing the HSQ-based porous network coating starts with depositing a coating on a substrate with a solution comprising a resin molecule containing at least 2 Si—H groups and a solvent. Those skilled in the art will understand that the resin molecules containing at least 2 Si—H groups are repeating units, which form the silicate backbone of the resin. The resins containing at least 2 Si—H groups are not particularly limited, as long as the Si—H bonds can be hydrolyzed and at least partially condensed by the basic catalyst and water to form a cross-linked network that serves as the structure for the porous network. Generally, such materials have the formula:

{R₃SiO_{½}}ₐ{R₂SiO_{22}}_{b}{RSiO_{3/2}}_{c}{SiO_{4/2}}_{d}

wherein each R is independently selected from the group consisting of hydrogen, alkyl, alkenyl, or aryl groups, or alkyl, alkenyl, or aryl groups substituted with a hetero atom such as a halogen, nitrogen, sulfur, oxygen, or silicon, and a, b, c, and d are mole fractions of the particular unit and their total is 1, with the proviso that at least 2 R groups per molecule are hydrogen and the material is sufficiently resinous in structure to form the desired network. Examples of alkyl groups are methyl, ethyl, propyl, butyl, and the like, with alkyls of 1-6 carbons being typical. Examples of alkenyl groups include vinyl, allyl, and hexenyl. Examples of aryls include phenyl. Examples of substituted groups include CF₃(CF₂)ₙCH₂CH₂, where n=0-6.

Useful in the present invention are various hydridosiloxane resins, known as hydrogen silsesquioxane resins, comprising units of the formula HSi(OH)ₓ(OR′)_{y}O_{z/2}. In this formula, each R′ is independently selected from the group consisting of alkyl, alkenyl, or aryl groups, or alkyl, alkenyl, or aryl groups substituted with a hetero atom such as a halogen, nitrogen, sulfur, oxygen, or silicon. Examples of alkyl groups are methyl, ethyl, propyl, butyl, and the like, with alkyls of 1-6 carbons being typical. Examples of alkenyl groups include vinyl, allyl, and hexenyl. Examples of aryls include phenyl. Examples of substituted groups include CF₃(CF₂)ₙCH₂CH₂, where n=0-6. When these R′ groups are bonded to silicon through the oxygen atom, they form a hydrolyzable substituent. In the above formula, x=0 to 2, y=0 to 2, z=1 to 3, and x+y+z=3. These resins may be essentially fully condensed (HSiO_{3/2})ₙ where n is 8 or greater, or they may be only partially hydrolyzed (i.e., containing some Si—OR′), and/or partially condensed (i.e., containing some Si—OH).

The structure of the resin containing at least 2 Si—H groups is not limited. The structure may be what is generally known as ladder-type, cage-type, or mixtures thereof. The HSQ resins may contain endgroups such as hydroxyl groups, triorganosiloxy groups, diorganohydrogensiloxy groups, trialkoxy groups, dialkoxy groups, and others. The HSQ resin may also contain a small number (e.g., less than 10%) of the silicon atoms, which have either 0 or 2 hydrogen atoms attached thereto and/or a small number of Si—C groups, such as CH₃SiO_{3/2} or HCH₃SiO_{2/2} groups.

The resins containing at least 2 Si—H groups and methods for their production are known in the art. For example, U.S. Pat. No. 3,615,272, to Collins et al., teaches the production of an essentially fully condensed hydrogen silsesquioxane resin (which may contain up to 100-300 ppm silanol) by a process comprising hydrolyzing trichlorosilane in a benzenesulfonic acid hydrate hydrolysis medium, and then washing the resulting resin with water or aqueous sulfuric acid. Similarly, U.S. Pat. No. 5,010,159, to Bank et al., teaches a method comprising hydrolyzing hydridosilanes in an arylsulfonic acid hydrate hydrolysis medium to form a resin which is then contacted with a neutralizing agent.

Other hydridosiloxane resins, such as those described in U.S. Pat. No. 4,999,397, to Weiss et al., and U.S. Pat. No. 5,210,160, to Saive et al., those produced by hydrolyzing an alkoxy or acyloxy silane in an acidic, alcoholic hydrolysis medium, those described in Japanese Kokai Patent Nos. 59-178749,60-086017, and 63-107122, or any other equivalent hydridosiloxanes, will also function herein.

Specific molecular weight fractions of the Si—H containing resins may also be used. Such fractions and methods for their preparation are taught in U.S. Pat. No. 5,063,267, to Hanneman et al., and U.S. Pat. No. 5,416,190, to Mine et al. A typical fraction comprises material wherein at least 75% of the polymeric-species have a number average molecular weight above about 1200, and a more typical fraction comprises material wherein at least 75% of the polymeric species have a number average molecular weight between about 1200 and about 100,000.

The Si—H containing resins may contain other components as long as these components do not interfere with the integrity of the coating. It should be noted, however, that certain materials may increase the dielectric constant of the coating.

Ceramic oxide precursors may also be used in combination with the Si—H containing resins. The ceramic oxide precursors useful herein include compounds of various metals such as aluminum, titanium, zirconium, tantalum, niobium and/or vanadium, as well as various non-metallic compounds, such as those of boron or phosphorus, which may be dissolved in solution, hydrolyzed and subsequently pyrolyzed at relatively low temperature to form ceramic oxides. Ceramic oxide precursors useful herein are described in U.S. Pat. Nos. 4,808,653 and 5,008,320 to Haluska et al., and 5,290,394 to Sasaki.

The Si—H containing resins are applied to the substrates as solvent dispersions to form a coating on the substrate (“SiH resin coating”). Solvents that may be used include any agent or mixture of agents that will dissolve or disperse the resin to form a homogeneous liquid mixture without affecting the resulting coating or the substrate. These solvents can include alcohols, such as ethyl alcohol or isopropyl alcohol; aromatic hydrocarbons, such as benzene or toluene; branched or linear alkanes, such as n-heptane, dodecane, or nonane; branched or linear alkenes, such as n-heptene, dodecene, or tetradecene; ketones, such as methyl isobutyl ketone; esters; ethers, such as glycol ethers; or linear or cyclic siloxanes, such as hexamethyidisiloxane, octamethyldisiloxane, and mixtures thereof, or cyclic dimethylpolysiloxanes; or mixtures of any of the above solvents. The solvent is generally present in an amount sufficient to dissolve/disperse the resin to the concentration desired for application. Typically, the solvent is present in an amount of about 20 to about 99.9 wt %, and more typically from about 70 to about 95 wt %, based on the weight of the resin and solvent.

If desired, other materials can be included in the resin dispersion. For instance, the dispersion can include fillers, colorants, adhesion promoters, and the like.

Specific methods for application of the resin dispersion to the substrate include, but are not limited to, spin coating, dip coating, spray coating, flow coating, screen printing, or others. A typical method is spin coating.

At least about 5 volume % of the solvent should remain in the SiH resin coating until the resin is contacted with the basic catalyst and water. This solvent forms the pores of the porous network coating as the Si—H bonds are hydrolyzed and condensed. In some embodiments, it may be typical that at least about 10 volume % solvent remains, while in others, it may be typical that at least about 15 volume % solvent remains, and in still others, it may be typical that at least about 25 volume % solvent remains.

The method of retaining the solvent is not particularly restricted. In a typical embodiment, a high boiling point solvent can be used alone or as a co-solvent with one of the solvents described above. In this manner, processing the resin dispersion as described above under normal conditions allows for at least about 5% residual solvent remaining. Typical high boiling solvents in this embodiment are those with boiling points above about 175° C. including hydrocarbons, aromatic hydrocarbons, esters, ethers, and the like. Examples of specific solvents which can be used in this embodiment include saturated hydrocarbons, such as dodecane, tetradecane, hexadecane, etc., unsaturated hydrocarbons, such as dodecene, tetradecene, etc., xylenes, mesitylene, 1-heptanol, dipentene, d-limonene, tetrahydrofurfuryl alcohol, mineral spirits, 2-octanol, stoddard solvent, Isopar HTM, diethyl oxalate, diamyl ether, tetrahydropyran-2-methanol, lactic acid butyl ester, isooctyl alcohol, propylene glycol, dipropylene glycol monomethyl ether, diethylene-glycol diethyl ether, dimethyl sulfoxide, 2,5-hexanedione, 2-butoxyethanol acetate, diethylene glycol monomethyl ether, 1-octanol, ethylene glycol, Isopar L™, dipropylene glycol monomethyl ether acetate, diethylene glycol monoethyl ether, N-methylpyrrolidone, ethylene glycol dibutyl ether, gamma-butyrolactone, 1,3-butanediol, diethylene glycol monomethyl ether acetate, trimethylene glycol, triethylene glycol dimethyl ether, diethylene glycol monoethyl ether acetate, alpha-terpineol, n-hexyl ether, kerosene, 2-(2-n-butoxyethoxy)ethanol, dibutyl oxalate, propylene carbonate, propylene glycol monophenyl ether, diethylene glycol, catechol, diethylene glycol monobutyl ether acetate, ethylene glycol monophenyl ether, diethylene glycol dibutyl ether, diphenyl ether, ethylene glycol monobenzyl ether, hydroquinone, sulfolane, and triethylene glycol. Hydrocarbon solvents are typical.

The above processing (i.e., primarily deposition of the SiH resin coating solution) can be done in an environment that inhibits solvent evaporation prior to contact with the basic catalyst and water. For example, the spin coating can be performed in a closed environment such that the subsequent steps (i.e., contact with the basic catalyst and water) can occur before the solvent is completely evaporated.

The SiH resin coating containing at least about 5 volume % solvent is then contacted with a basic catalyst and water. Examples of basic catalysts include ammonia, ammonium hydroxide, as well as amines. The amines useful herein may include primary amines (RNH₂), secondary amines (R₂NH), and/or tertiary amines (R₃N) in which R is independently a saturated or unsaturated aliphatic, such as methyl, ethyl, propyl, vinyl, allyl, ethynyl, etc.; an alicyclic, such as cyclohexylmethyl; an aromatic, such as phenyl; a substituted hetero atom, such as oxygen, nitrogen, sulfur, etc.; or compounds in which the nitrogen atom is a member of a heterocyclic ring such as quinoline, pyrrolidine, or pyridine. In addition, any of the above amine compounds may be substituted with other hydrocarbon and/or hetero containing groups to form compounds such as diamines, amides, etc. Finally, it is also contemplated that compounds, which are converted to amines under the reactions conditions used, would function in an equivalent manner. For example, a compound such as an ammonium salt that yields an amine upon dissolution would provide the desired catalytic effect.

Examples of the amines that may be used herein include methylamine, ethylamine, butylamine, allylamine, cyclohexylamine, aniline, dimethylamine, diethylamide, dioctylamine, dibutylamine, methylethylamine, saccharin, piperidine, trimethylamine, triethylamine, pyridine, diethyl toluidene ethylmethylpropylamine, imidazole, choline acetate, triphenyl phosphene analine, trimethylsilylimidazole, ethylenediamine, diethylhydroxylamine, triethylenediamine, n-methylpyrolidone, etc.

The basic catalyst can generally be used at any concentration sufficient to catalyze hydrolysis of the Si—H bonds. Generally, concentrations of the basic catalyst can be from about 1 ppm to about 100 wt % based on the weight of the resin, depending on the basic catalyst.

The water used can be that present in the ambient environment (e.g., >about 25% relative humidity), the ambient environment can be supplemented with additional water vapor (e.g., relative humidity up to about 100%), water can be used as a liquid, or a compound which generates water under the reaction conditions can be used.

Contact of the SiH resin coating with the basic catalyst and water can be accomplished by any means practical or desirable. For instance, the SiH resin coating can be contacted with vapors of the basic catalyst and water vapor. Alternatively, the SiH resin coating can be contacted with the basic catalyst and water in the liquid state, such as by immersing the coating in an ammonium hydroxide solution.

The SiH resin coating is typically exposed to an environment comprising the basic catalyst and water in the vapor state, more typically ammonia and water vapor. For instance, the SiH resin coated substrate may be placed in a container and the appropriate environment introduced therein, or a stream of the basic catalyst and water may be directed at the SiH resin coating.

The method used to generate the basic catalyst and water environment is generally not significant in the present embodiment. Methods such as bubbling the basic catalyst (e.g., ammonia gas) through water or ammonium hydroxide solutions (to control the amount of water vapor present), heating a basic catalyst and water, or heating water and introducing the basic catalyst gas (e.g., ammonia gas) are all functional herein. It is also contemplated that methods, which generate basic catalyst vapors in situ, such as the addition of water to amine salts, or the addition of water to a silazane, such as hexamethyldisilazane, will also be effective.

The basic catalyst used may be at any concentration desired. For example, the concentration may be from about 1 ppm up to a saturated atmosphere.

The exposure can be at any temperature desired from room temperature up to about 300° C. A temperature in the range of from about 20° C. to about 200° C. is typical, with a range of from about 20° C. to about 100° C. being more typical.

The SiH resin coating should be exposed to the basic catalyst and water environment for the time necessary to hydrolyze the Si—H groups to form silanols (Si—OH) and for the silanols to at least partially condense to form Si—O—Si bonds. Generally, exposures of up to about 20 minutes are typical, with exposures of at least about 1 second up to about 5 minutes being more typical. If the coatings are to be used as a dielectric layer, it is generally typical to have a shorter exposure, as longer exposures tend to increase the dielectric constant of the coating.

When the coating is exposed to the basic catalyst and water in the liquid state, the exposure is usually conducted by immersing the coated substrate in a solution. Other equivalent methods can be used, such as flushing the coating with a basic catalyst and water solution. In addition, vacuum infiltration may also be used to increase penetration of the basic catalyst and water into the coating.

The basic catalyst solution used in this embodiment may be at any concentration desired. Generally when ammonium hydroxide is used, a concentrated aqueous solution of between about 28 and about 30% is typical since the duration of exposure is thereby shortened. When dilute solutions are used, the diluent is generally water.

Exposure to the basic catalyst and water solution in this embodiment may be conducted at any temperature and pressure desired. Temperatures from about room temperature (20-30° C.) up to about the boiling point of the basic catalyst solution, and pressures from below to above atmospheric are all contemplated herein. From a practical standpoint, it is typical that the exposure occur at about room temperature and at about atmospheric pressure.

The resin coating is exposed to the basic catalyst solution in this embodiment for the time necessary to hydrolyze the Si—H groups to form silanols (Si—OH) and for the silanols to at least partially condense to form Si—O—Si bonds. Generally, exposures of up to about 2 hours are typical, with exposures of at least about 1 second up to about 15 minutes being more typical.

Alternatively, the coating may be exposed to both a liquid basic catalyst and water environment (e.g., ammonium hydroxide) and a gaseous basic catalyst and water vapor environment (ammonia gas and water vapor). The exposures may be either sequential or simultaneous, and are generally under the same conditions as those described above.

After the resin is exposed to one of the above environments, the solvent is then removed from the coating. This can be accomplished by any desired means, including but not limited to, heating the coating, and by vacuum. When the solvent is removed by heating the coating, condensation of the remaining silanols may be facilitated.

The coating produced by this process can be used as the starting material (“porous network coating”) in the present invention. In a typical procedure to produce a porous network coating, a substrate is coated with the Si—H containing resin and solvent in a manner that ensures that at least about 5 volume % of the solvent remains in the coating. The coating is then exposed to the basic catalyst and water, and the solvent is evaporated.

As noted herein, gelation of low-k dielectric materials by treatment with ammonia can cause adverse effects for other process steps. In accordance with one embodiment of the present invention, a method of forming a coating on a substrate is provided comprising depositing a coating on a substrate with a solution comprising a resin molecule containing at least 2 Si—H groups, at least 2 Si—CH₃ groups, or a combination thereof, and a solvent in a manner in which at least about 5 volume % of the solvent remains in the coating after deposition. The method further comprises exposing the coating to UV radiation at a power and wavelength spectrum sufficient to cause hydrolysis of the Si—H groups, Si—CH₃ groups, or combination thereof, and at least partial condensation, and evaporating the solvent from the coating to form a porous network coating.

The low-temperature UV pretreating of porous low-k resins results in the gelation of these resins, such that the Si—H or Si—CH₃ groups are hydrolyzed to form silanols (Si—H) which at least partially condense to form Si—O—Si bonds, thus eliminating the need for an ammonia treatment. This low-temperature UV pretreatment process may be utilized in conjunction with a subsequent plasma and/or UV cure, as disclosed herein, as well as within the following U.S. patent applications: U.S. patent application Ser. Nos. 09/952,649, 09/906,276, 09/681,332 (now U.S. Pat. No. 6,558,775), and 09/952,398, and Attorney Docket No. AXC 0001 13 (01-SM5-218 CIP2), the disclosures of which are all hereby incorporated by reference.

In a typical low-temperature UV pretreating process, a UV radiator tool is utilized, which is first purged with nitrogen, argon, or a similar inert UV transparent gas to allow the UV radiation to enter the process chamber with minimal spectral absorption. The process chamber is purged separately, which is typically oxygen or an oxygen-containing gas such as N₂O or a similar O-promoting gas mixture, to maximize the UV pretreatment efficiency. UV generating bulbs with different spectral distributions may be selected depending on the low-k material selected and process application. The wafer temperature may be controlled ranging from about room temperature to about 100° C., but is maintained initially at about room temperature to ensure that the low-k resin is gelating before the solvents are evaporated out of the film.

Examples of typical low-temperature UV pretreatment conditions for a 200 mm wafer are shown below.

| | |
|---|---|
| UV Power: | 0.1 mW-1000 mW/cm² |
| UV Wavelength: | continued spectral distribution for |
| | <400 nm |
| Wafer Temperature: | room temp.—100° C. |
| Process Pressure: | <, >, or = to atmospheric |
| UV Pretreatment Time: | <600 seconds |
| UV Chamber Purge Gas: | oxygen or oxygen-containing gas |
| Forming Gas (FG) Flow Rate: | purge |
| O₂ Flow Rate: | purge |
| N₂ Flow Rate: | purge |
| H₂/N₂ Gas Mixture Flow Rate: | purge |

Although not wishing to be bound to any particular theory, it is contemplated that the gelation of the low-k dielectric resin material by low-temperature UV pretreating is effected by UV assisted ozone generation, rather than direct interaction of photons with the dielectric. This is most likely the case even though there may be a small effect of direct photon interaction with the dielectric or atomic oxygen interaction with the dielectric, given a small cure effect with a nitrogen gas purge, wherein no ozone was detected. However, the predominant mechanism for the low-temperature UV pretreatment process of the present invention is most likely ozone generation. Consequently, as noted above, typical low-temperature UV pretreatment conditions include oxygen or oxygen-containing gas purges at lower wavelengths, which promote ozone generation.

Although the instant low-temperature UV pretreating process is most applicable to spun-on HSQ- and MSQ-based porous low-k materials, it may have other applications, such as a substitute for any process that traditionally employs an ammonia treatment for gelation of porous low-k materials. It is also contemplated that the low-temperature UV pretreatment process of the present invention enables the fabrication of low-k dielectric film in an integrated process tool, which can be comprised of (i) a plasma module, (ii) a rapid thermal anneal module, (iii) a UV module, and (iv) a spin track module. It is further contemplated that this single integrated process system could conduct all of the process steps for an entire low-k film deposition sequence, beginning with the resin solution up to the finished fully cured low-k dielectric film.

Another method of making such a porous network coating is to thermally cure a siloxane resin containing large alkyl groups and to thermally decompose the alkyl groups to create porosity in the coating. As disclosed in U.S. Pat. Nos. 6,143,360 and 6,184,260, to Zhong, which are hereby incorporated herein by reference, hydridosilicon containing resin was allowed to contact with a 1-alkene comprising about 8 to about 28 carbon atoms in the presence of a platinum group metal-containing hydrosilation catalyst, effecting formation of an alkylhydridosiloxane resin where at least about 5 percent of the silicon atoms are substituted with at least one hydrogen atom, and the resulting resin was heated at a temperature sufficient to effect curing of the resin and thermolysis of alkyl groups from the silicon atoms, thereby forming a nanoporous silicone resin.

U.S. Pat. Nos. 6,232,424, 6,359,096 and 6,313,045, and U.S. patent application Ser. No. 425,901, to Zhong et al., which are hereby incorporated herein by reference, disclose silicone resins and porous coatings made from the silicone resins. The silicone resins are made from a mixture compromising 15 to 70 mol % of tetraalkoxysilane, 12 to 60 mol % of an organosilane described by formula R′SiX₃, where R′ is a hydrogen or alkyl group containing 1 to 6 carbon atoms, and 15 to 70 mol % of an organotrialkyoxysilane described by formula R″Si(OR′″)₃, where R″ is a hydrocarbon group compromising about 8 to 24 carbon atoms or a substituted hydrocarbon group compromising a hydrocarbon chain having about 8 to 24 carbon atoms.

U.S. patent application Ser. No. 09/951,819 entitled “SILICONE RESINS AND POROUS MATERIALS PRODUCED THEREFROM”, to Zhong, filed Sep. 12, 2001 and hereby incorporated herein by reference, discloses porous coatings made from silicone resins having the general formula (R¹SiO_{3/2})ₓ(HSiO_{3/2})_{y} where R¹ is an alkyl group having 8 to 24 carbon atoms. The coatings produced therein have a dielectric constant between 1.5 and 2.3. The above-referenced patent application further provides the following description of a porous low-k dielectric coating made in two steps from a resin with a formula of (R¹SiO_{3/2})ₓ(HSiO_{3/2})_{y} where R¹ is 3, 7, 11, 15-tetramethyl-3-hydroxy-hexadecyl.

U.S. patent application Ser. No. 09/951,899 entitled “SILICONE RESINS AND POROUS MATERIALS PRODUCED THEREFROM”, to Zhong, filed Sep. 12, 2001 and hereby incorporated herein by reference, discloses porous coatings made from silicone resins having the general formula (R¹SiO_{3/2})ᵤ(HSiO_{3/2})ᵥ(SiO_{4/2})_{w}(HOSiO_{3/2})_{z} where R¹ is a branched alkyl group having 8 to 24 carbon atoms containing at least one electron-withdrawing group in a pendant position on the alkyl chain; u has a value of 0.1 to 0.7; v has a value of 0.12 to 0.6; z≧0.5; w+z has a value of 0.15 to 0.7; and u+v+w+z=1.

Step 1. A resin sample was prepared by combining components (A), (B), (C), (D), (E), and (F) as described below in the amounts described in Table 1 of the above-referenced U.S. patent application:

(A) 0.45 mole parts of triethoxysilane,

(B) 0.25 mole parts of an-organotriethoxysilane, RSi(OR′)₃ where R is 3,7,11,15-tetramethyl-3-hydroxy-hexadecyl,

(C) 0.30 mole parts of tetraethoxysilane, and

(D) a mixture of methyl isobutyl ketone (MIBK) and isobutyl isobutyrate (6:4 weight ratio), enough to make the concentration of the resulting resin 9%.

To this mixture was added a mixture of (E) water and (F) hydrogen chloride in the amounts described in Table 1 of the above-referenced application. The resulting reaction product was stripped of volatiles under reduced pressure at 60° C. until the solid content became 14 to 21 %. Isobutyl isobutyrate was added to make the solid content 14%. The solution was then heated to reflux for 2 hours and water produced was removed continuously. The solvent was then changed to cyclohexanone by stripping off isobutyl isobutyrate and adding cyclohexanone.

Step 2. The resulting resin solution was spin-coated onto silicon wafers suitable for dielectrc constant measurements, and cured in a nitrogen flow at 440° C. for 1 hour. The dielectric constant was measured as 1.9. Alternatively, the curing of the spin-coated films may be accelerated with plasma and/or UV assisted processes.

U.S. patent application Ser. No. 09/915,899 to Albaugh et al., which is hereby incorporated herein by reference, discloses porous coatings from resins containing ,(RSiO_{3/2})(R′SiO_{3/2})(R″SiO_{3/2}) resins wherein R is an alkyl group having 1 to 5 carbon atoms or a hydrogen atom, R′ is a branched alkoxy group and R″ is a substituted or un-substituted linear, branched, or cyclic monovalent organic group having 6 to 30 carbon atoms.

U.S. patent application Ser. Nos. 09/915,903, to Boisvert et al., and 09/915,902, to Albaugh et al., which are hereby incorporated herein by reference, disclose porous coatings made from resins of the formula TRTR′ where R is either a methyl or hydrogen group and a R′ is a branched alkoxy group.

Although porous dielectric materials having low dielectric constants are desirable, it would be advantageous to have a porous dielectric material with a higher elastic modulus and material hardness.

In order to raise the elastic modulus of the porous dielectric material, it is exposed to a UV curing process. The UV curing process improves the mechanical properties of the porous low-k dielectric material, increasing material hardness while maintaining the dielectric pore, structure, density, and electrical properties.

In a typical UV curing process, a UV radiator tool is utilized, which is first purged with nitrogen, helium, or argon to allow the UV radiation to enter the process chamber with minimal spectral absorption. The process chamber is purged separately and process gases, such as N₂, H₂, Ar, He, Ne, H₂O vapor, CO_{z}, O_{z}, CₓH_{y}, CₓF_{y}, CₓH_{z}F_{y}, air, and mixtures thereof, wherein x is an integer between 1 and 6, y is an integer between 4 and 14, and z is an integer between 1 and 3, may be utilized for different applications. In this regard, UV curing can occur at vacuum conditions, or at conditions without the presence of oxygen or oxidizing gases. UV generating bulbs with different spectral distributions may be selected depending on the application, such as, for example, HL or HL-bulbs available from Axcelis Technologies, Inc (Beverly, Mass.). As such, the UV light source can be microwave driven, arc discharge, dielectric barrier discharge, or electron impact generated. The wafer temperature may be controlled ranging from about room temperature to about 450° C., optionally by an infrared light source, an optical light source, a hot surface, or the UV light source itself. The process pressure can be less than, greater than, or about equal to atmospheric pressure.

Examples of typical UV cure conditions for a 200 mm wafer are shown below.

| | |
|---|---|
| UV Power: | 0.1 mW-2000 mW/cm² |
| UV wavelength: | continued spectral distribution from 100-600 nm |
| Wafer Temperature: | room temp.—450° C. |
| Process Pressure: | <, >, or = to atmospheric |
| UV Cure Time: | <300 seconds |
| Process Gases: | He/Ne/Ar/H₂/N₂/H₂O/CO/CO₂/CₓH_{y}/O₂/CₓH_{z}F_{y} |

The elastic modulus and material hardness of the UV cured porous dielectric materials are increased as compared to furnace (thermally) cured or uncured porous dielectric materials. A furnace cured or uncured porous dielectric material has typically an elastic modulus between about 1.0 GPa and about 3.5 GPa when the dielectric constant is between about 1.6 and about 2.4. Typically, the elastic modulus of the UV cured porous dielectric material is greater than or about 2.5 GPa, and more typically between about 4 GPa and about 10 GPa. The material hardness of the furnace cured or uncured films is about 0.1 GPa. Typically, the material hardness of the UV cured porous dielectric material is greater than or about 0.25 GPa, and more typically between about 0.25 GPa and about 1.2 GPa.

The UV cured porous dielectric materials of the present invention have improved chemical stability and improved dimensional stability. By improved “chemical stability”, we mean that the porous dielectric materials are more resistant to chemicals, such as cleaning solutions and chemical polishing solutions, and plasma damaging during photoresist ashing and dry etching processes.

However, for some low-k materials and process gas combinations, the UV cure process can generate some unwanted polar species in the porous dielectric materials. In these cases, the UV cured porous dielectric materials can optionally be post-UV treated using thermal, UV, or plasma exposure to reduce the dielectric constant and/or further increase the elastic modulus and material hardness, if desired. For example, the UV cured porous dielectric materials can be annealed by placing the materials in a conventional oven until the polar species are removed, such as at a temperature of between about 400° C. and about 450° C. for between about,30 and about 60 minutes. An alternative process for annealing the materials involves annealing the UV cured porous dielectric materials in a Rapid Anneal Processing (RAP) chamber in order to reduce the dielectric constant. The UV cured porous dielectric material is annealed at a typical temperature for a sufficient time, and cooled to about 100° C. However, RAP may not be necessary in some applications.

Typical operating conditions for the RAP process are shown below.

| | |
|---|---|
| Ramp rate: | 15-150° C./sec |
| Wafer Temperature: | 150-450° C. |
| Annealing Time: | <120 seconds |
| Process Pressure: | atmospheric |
| Atmosphere: | N₂ |

The post-UV treatment can also be performed by exposing the UV cured porous dielectric material to an additional UV condition. Typically, the UV cured porous dielectric material is UV treated for no more than or about 300 seconds and, more particularly, between about 60 and about 180 seconds. Also, UV treating can be performed at a temperature between about room temperature and about 450° C.; at a process pressure that is less than, greater than, or about equal to atmospheric pressure; at a UV power between about 0.1 and about 2000 mW/cm²; and a UV wavelength spectrum between about 100 and about 400 nm. Moreover, the UV cured porous dielectric material can be UV treated with a process gas purge, such as N₂, O_{z}, Ar, He, H₂, H₂O vapor, CO_{z}, CₓH_{y}, CₓF_{y}, CₓH_{z}F_{y}, air, and combinations thereof, wherein x is an integer between 1 and 6, y is an integer between 4 and 14, and z is an integer between 1 and 3.

Another type of post-UV treatment that can be used involves the exposure of the UV cured porous dielectric materials to a plasma condition at elevated temperatures. In a typical plasma-assisted post-UV treatment, process gases, such as O₂, N₂, H₂, Ar, He, CₓH_{y}, fluorine-containing gas, and mixtures thereof, wherein x is an integer between 1 and 6, and y is an integer between 4 and 14, may be utilized for different applications. The wafer temperature may be controlled ranging from about room temperature to about 450° C. Typically, the UV cured porous dielectric material is plasma treated at a process pressure between about 1 Torr and about 10 Torr.

Examples of typical plasma-assisted post-UV treatment conditions for 200 mm and 300 mm wafers are shown below.

| Condition | 200 mm system | 300 mm syst m |
|---|---|---|
| Microwave Plasma | 500 W-3000 W | 500 W-3000 W |
| Power: | | |
| Wafer Temperature: | 80° C.-350° C. | 80° C.-350° C. |
| Process Pressure: | 1.0 Torr-3.0 Torr | 1.0 Torr-4.0 Torr |
| Plasma Treatment Time: | <90 seconds | <90 seconds |
| Plasma Gases: | H₂/N₂/CF₄/O₂/Ar/He/ | H₂/N₂/CF₄/O₂/Ar/He/ |
| | CₓH_{y} | CₓH_{y} |
| N₂H₂ Flow Rate: | >0-4000 sccm | >0-10,000 sccm |
| O₂ Flow Rate: | >0-4000 sccm | >0-10,000 sccm |
| CF₄ Flow Rate: | >0-400 sccm | >0-1000 sccm |
| Ar Flow Rate: | >0-4000 sccm | >0-10,000 sccm |
| He Flow Rate: | >0-4000 sccm | >0-10,000 sccm |

The dielectric constant of the post-UV treated, UV cured porous dielectric materials is reduced as compared to the UV cured porous dielectric materials. The dielectric constant of the post-UV treated, UV cured porous dielectric materials is typically between about 1.1 and about 3.5, and more typically between about 1.6 and about 2.4.

Typical material properties of porous low-k films with UV curing are shown in Table 1 below.

TABLE 1
Porous Low-K Material Characteristics with UV Curing

| | MSQ-Based Porous | HSQ-Based Porous |
|---|---|---|
| Materials Properties | Dielectric Material | Dielectric Material |
| Change in Dielectric | <0.1 | <0.2 |
| Constant | | |
| Modulus Increase | ≧50% | ≧50% |
| Porosity | Unchanged | Unchanged |
| Compatible UV Curing | Vacuum, Ar, He, Ne, | Vacuum, N₂/H₂, |
| Process Gases | H₂, NH₃, CO₂, | Ar, He, Ne, NH₃, O₂, |
| | CO, N₂/H₂ | H₂, H₂O |
| Density | Unchanged | Unchanged |
| Thickness Loss | <10% | <10% |
| Refractive Index Change | <0.01 | <0.03 |

In order that the invention may be more readily understood, reference is made to the following examples, which are intended to illustrate the invention, but not limit the scope thereof.

### EXAMPLE 1

Low-Temperature UV Pretreating of HSQ-Based Porous Low-K Film

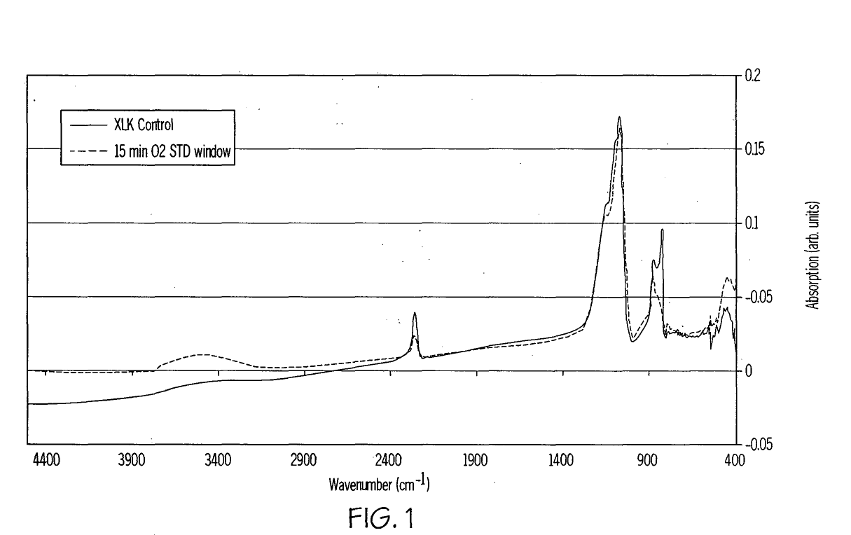

The following example shows the low-temperature UV pretreatment effect on an HSQ-based porous low-k film (XLK, available from Dow Corning Corporation, Midland, Mich.). FIG. 1 shows FTIR spectra before and after room temperature UV exposure. The room temperature UV pretreating was applied for about 15 minutes with an oxygen chamber purge, utilizing an HL-spectra bulb with a standard irradiator window. It is illustrated that that the low-temperature UV exposure reduced the Si—H peak intensity (near 2200 cm⁻¹ and 830-880 cm⁻¹) and increased the (Si—O network)/(Si—O cage) peak ratio (near 1000 cm⁻¹), both of which are clear indications for the enhanced gelation of the porous low-k film.

The following graphs show the attributes of the UV curing. Examples are presented for (i) blanket MSQ-based porous low-k thin films, (ii) blanket HSQ-based porous low-k thin films, and (iii) blanket MSQ/HSQ mixed porous low-k films, all with a thickness of approximately 5000 Å.

### EXAMPLE 2

MSQ-Based Porous Low-K Film

The FTIR spectra of MSQ-based porous low-k films are characterized by Si—CH₃ characteristic bands near 1280 cm⁻¹ and 3000 cm⁻¹, as well the two Si—O peaks near 1100 cm⁻¹. The curing of these films which typically results in a modulus increase of 100% or more is reflected in the FTIR spectra by the partial removal of the Si—CH₃ bands, and the change in the ratio of cage (higher wavenumber) vs. network (lower wavenumber) Si—O bonds.

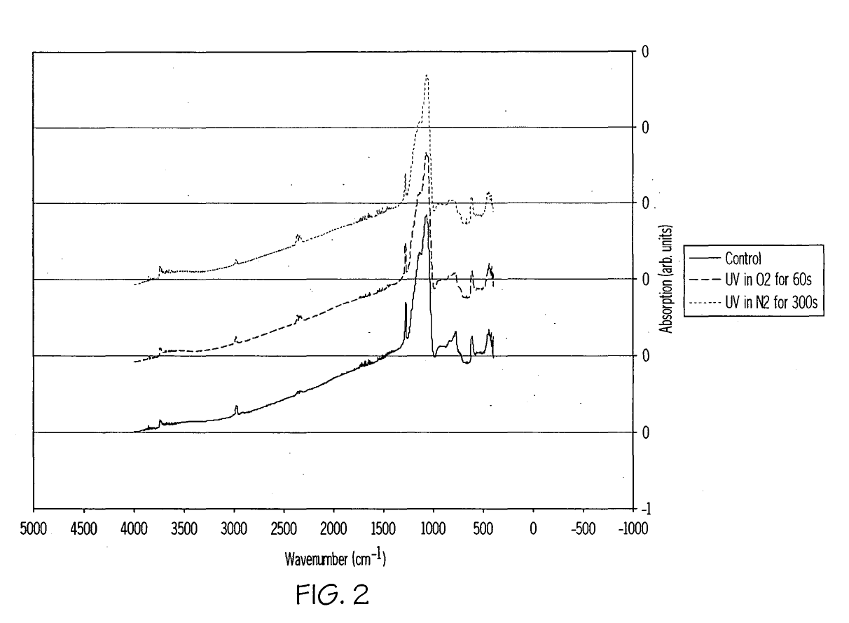

The UV treatment can successfully cure the MSQ-based porous low-k films. FIG. 2 shows FTIR spectra for MSQ-based porous low-k films: thermally cured (bottom), thermally+UV cured in O₂ for 1 minute (center), and thermally+UV cured in N₂ for 5 minutes (top). The curing effectiveness is strongly dependent on the chamber purge gas composition. It has been observed that O₂ is more effective for the UV curing than N₂.

### EXAMPLE 3

HSQ-Based Porous Low-K Film (Dow Corning's XLK)

The FTIR spectra of HSQ-based porous low-k films are characterized by the Si—H band near 2200 cm⁻¹, a band near 850 cm⁻¹ which is attributed to a SiO—H stretch mode and the two Si—O peaks near 1100 cm⁻¹. The curing of these films which typically results in a modulus increase of 100% or more is reflected in the FTIR spectra by the complete removal of the Si—H band, and the change in ratio of cage vs. network Si—O bonds.

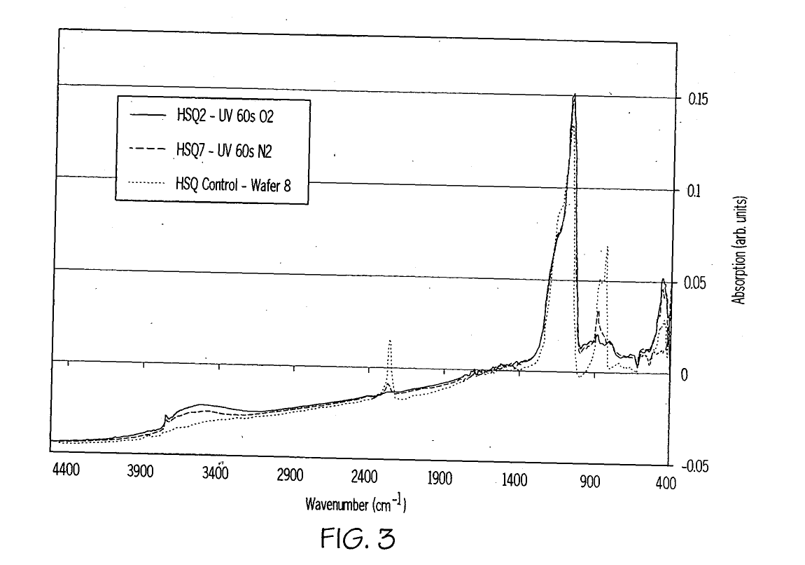

The UV treatment can successfully cure the HSQ-based porous low-k films. FIG. 3 shows FTIR spectra for HSQ-based porous low-k films: uncured (dotted line), UV cured for 60 seconds in N₂ (dashed line) and O₂ (solid line). However, the efficiency for the curing is dependent on the chamber purge gas composition. It has been observed that O₂ is more effective for the UV curing than N₂.

### EXAMPLE 4

HSQ/MSQ Mixed Porous Low-K Film (Dow Corning)

The FTIR spectra of HSQ/MSQ-mixed porous low-k films are characterized by the usual Si—H band near 2200 cm⁻¹, the SiO—H stretch mode band near 850 cm⁻¹ and the two Si—O peaks near 1100 cm⁻¹. In addition there is the Si—CH₃ characteristic feature near 1280 cm⁻¹. For this specific example a 5% MSQ/95% HSQ mixed film has been studied. The UV curing of these films exhibits a much stronger dependence on the UV purge gas mixture than the pure HSQ-based porous film. Nevertheless, the O₂ purged UV treatment results in an effective and successful curing of the low-k films.

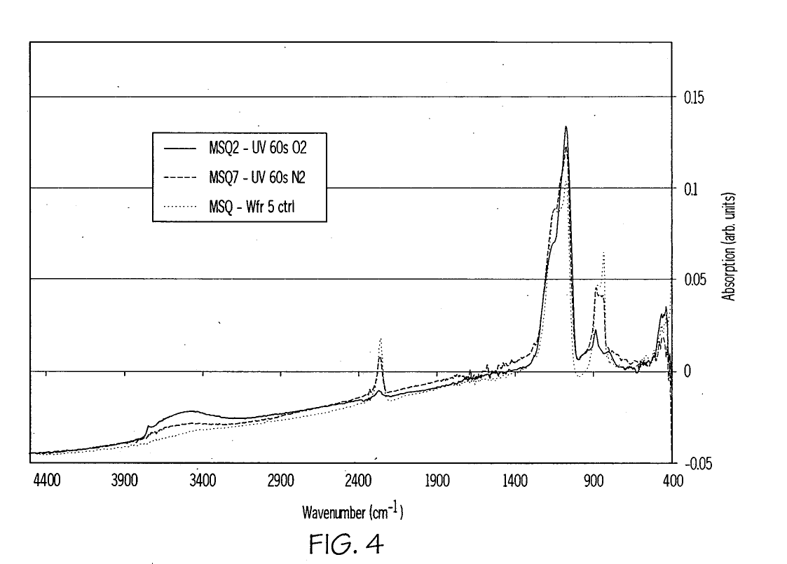

FIG. 4 shows FTIR spectra for 5% MSQ/95% HSQ-based porous low-k films: uncured (dotted line), UV cured for 60 seconds in N₂ (dashed line), and O₂ (solid line). For all cases a subsequent or possibly concomitant anneal step is necessary in order to remove the Si—OH bonds which are typically generated during the UV curing process.

While certain representative embodiments and details have been shown for purposes of illustrating the invention, it will be apparent to those skilled in the art that various changes in the compositions and methods disclosed herein may be made without departing from the scope of the invention. Accordingly, it is intended that the invention not be limited to the disclosed embodiments, but that it have the full scope permitted by the language of the following claims.

What is claimed is:

1. A method of forming a coating on a substrate comprising:
depositing a coating on a substrate with a solution comprising a resin molecule containing at least 2 Si—H groups, at least 2 Si—CH₃ groups, or a combination thereof, and a solvent in a manner in which at least about 5 volume % of the solvent remains in the coating after deposition;
exposing the coating to UV radiation at a power and wavelength spectrum sufficient to cause hydrolysis of the Si—H groups, Si—CH₃ groups, or combination thereof, and at least partial condensation; and
evaporating the solvent from the coating to form a porous network coating.

2. The method of claim 1 wherein the resin molecule containing at least 2 Si—H groups has the formula:
{R₃SiO_{½}}ₐ{R₂SiO_{2/2}}_{b}{RSiO_{3/2}}_{c}{SiO_{4/2}}_{d}
wherein each R is independently selected from the group consisting of hydrogen, alkyl, alkenyl, and aryl groups or alkyl, alkenyl, and aryl groups substituted with halogen, nitrogen, oxygen, sulfur or silicon atoms, with the proviso that at least 2 R groups are hydrogen.

3. The method of claim 2 wherein the resin molecule comprises a hydrogen silsesquioxane resin molecule of the structure selected from the group consisting of (HSiO_{3/2})ₙ, a polymer having units of the formula HSi(OH)ₐ O_{3-x/2}, or a polymer having units of the formula HSi(OH)ₓ(OR)_{y}O_{z/2}, wherein each R is independently an organic group which, when bonded to silicon through the oxygen atom, forms a hydrolyzable substituent, a=0 to 2, x=0 to 2, y=0 to 2, z=1 to 3, x+y+z=3, n is an integer greater than 3 and the average value of y over all of the units of the polymer is greater than 0.

4. The method of claim 1 wherein the solvent is selected from the group consisting of alcohols, aromatic hydrocarbons, alkanes, alkenes, ketones, esters, ethers, or mixtures thereof and is present in an amount sufficient to dissolve the resin molecule to between about 0.1 and about 95 weight percent.

5. The method of claim 4 wherein the solvent has a boiling point greater than or about 175° C.

6. The method of claim 4 wherein the solvent is a mixture of solvents and at least one of the solvents has a boiling point greater than or about 175° C.

7. The method of claim 5 wherein the solvent with a boiling point greater than or about 175° C. is a hydrocarbon.

8. The method of claim 6 wherein the solvent with a boiling point greater than or about 175° C. is a hydrocarbon.

9. The method of claim 1 wherein the substrate is coated in a closed environment to inhibit evaporation of the solvent.

10. The method of claim 1 wherein the coating is exposed to UV radiation for up to about 600 seconds.

11. The method of claim 1 wherein the substrate has a wafer temperature that is maintained initially at about room temperature to ensure that hydrolysis and at least partial condensation of the Si—H groups, Si—CH₃ groups, or combination thereof, has occurred before the solvent has been evaporated.

12. The method of claim 1 wherein the coating is exposed to UV radiation at a process pressure that is less than or about equal to atmospheric pressure.

13. The method of claim 1 wherein the coating is exposed to UV radiation at a process pressure that is greater than or about equal to atmospheric pressure.

14. The method of claim 1 wherein the coating is exposed to UV radiation at a UV power between about 0.1 and about 1000 mW/cm².

15. The method of claim 1 wherein the coating is exposed to UV radiation with a gas purge selected from the group consisting of oxygen gas and oxygen-containing gas.

16. The method of claim 1 wherein the coating is exposed to UV radiation using a UV wavelength spectrum that is less than or about 400 nm.

17. A porous network coating prepared by the method of claim 1.

18. A substrate having a porous network coating prepared by the method of claim 1.

19. An electronic device containing a porous network coating prepared by the method of claim 1.

20. An ammonia-free process for forming a coating on a substrate comprising:
depositing a coating on a substrate with a solution comprising a resin molecule containing at least 2 Si—H groups, at least 2 Si—CH₃ groups, or a combination thereof, and a solvent in a manner in which at least about 5 volume % of the solvent remains in the coating after deposition;
gelating the resin without the use of ammonia by exposing the coating to UV radiation at a power and wavelength spectrum sufficient to cause hydrolysis of the Si—H groups, Si—CH₃ groups, or combination thereof, and at least partial condensation; and
evaporating the solvent from the coating to form a porous network coating.

21. The process of claim 20 wherein the coating is exposed to UV radiation for up to about 600 seconds.

22. The process of claim 20 wherein the substrate has a wafer temperature that is maintained initially at about room temperature to ensure that hydrolysis and at least partial condensation of the Si—H groups, Si—CH₃ groups, or combination thereof, has occurred before the solvent has been evaporated.

23. The process of claim 20 wherein the coating is exposed to UV radiation at a process pressure that is less than or about equal to atmospheric pressure.

24. The process of claim 20 wherein the coating is exposed to UV radiation at a process pressure that is greater than or about equal to atmospheric pressure.

25. The process of claim 20 wherein the coating is exposed to UV radiation at a UV power between about 0.1 and about 1000 mW/cm².

26. The process of claim 20 wherein the coating is exposed to UV radiation with a gas purge selected from the group consisting of oxygen gas and oxygen-containing gas.

27. The process of claim 20 wherein the coating is exposed to UV radiation using a UV wavelength spectrum that is less than or about 400 nm.
